(19) United States
(12) Patent Application Publication
(10) Pub. No.: US 2011/0154270 A1
(43) Pub. Date: Jun. 23, 2011

(54) IMAGE DISPLAY SYSTEM, IMAGE DISPLAY DEVICE, PROGRAM, AND RECORDING MEDIUM

(76) Inventors: Yasuyuki Sonoda, Osaka (JP); Naoya Takao, Hyogo (JP); Tatsuaki Mitsumata, Nara (JP)

(21) Appl. No.: 13/060,723

(22) PCT Filed: Jun. 24, 2009
(86) PCT No.: PCT/JP2009/002890

§ 371 Date: Feb. 25, 2011

(30) Foreign Application Priority Data
Aug. 29, 2008 (JP) 2008-221408

(51) Int. Cl. G06F 3/048

(52) U.S. Cl. 715/867

(57) ABSTRACT

To prevent activation of a screen saver function during reproduction in an image display device, of a movie content of a HDD recorder. The HDD recorder includes a content server that stores content information including a program that is in a script format and that controls a generation timing of a screen saver screen, and video stream information. The image display device includes a script processing unit that acquires the content information from the content server and executes the program in script format and a stream processing unit that acquires the video stream information from the content server and decodes the video stream information. The script processing unit executes the program in script format, does not have a screen saver processing unit perform rendering of a screen saver screen during decoding of the video stream, and generates and displays a screen saver after completion of decoding.

### CROSS-REFERENCE TO RELATED APPLICATIONS

This application is a U.S. national phase application of PCT International Patent Application No. PCT/JP2009/002890 filed Jun. 24, 2009, claiming the benefit of priority of Japanese Patent Application No. 2008-221408 filed Aug. 29, 2008, all of which are incorporated by reference herein in their entirety.

### TECHNICAL FIELD

The present invention relates to an image display system, an image display device, a program, and a recording medium, more particularly, relates to such system etc. capable of appropriately displaying a screen saver screen when the screen saver screen is displayed, in a system in which two or more devices operate in cooperation with each other, as like such a case where a video program stored in a server such as a DVD recorder or a hard disk recorder (HDD recorder) is displayed on an image display device such as a television or a personal computer.

### BACKGROUND ART

Screen savers have been initially developed in order to prevent burn-in on a display device of a personal computer. Normally, on a display screen of a personal computer, a same screen is continuously displayed unless an operation on a keyboard or a mouse is performed by a user. However, when an unchanging screen is continuously displayed over a long period of time, a burn-in of a display pixel sometimes occurs and creates a permanent shadow.

For this reason, screen saver processing has been developed which prevents burn-in of pixels when an operation on a keyboard or a mouse is not performed by an operator for a predetermined amount of time, by switching a display screen to a screen saver screen which displays an image whose color or shape varies, so as to prevent a single pixel from being in a same display state over a long period of time.

Subsequently, a power-saving screen saver screen that reduces luminance of a screen saver screen in order to reduce power consumption of a display device, has also come into use.

Furthermore, as personal computers become capable of displaying a plurality of applications on a single display device due to the introduction of a so-called multi-window function, an entire screen is disadvantageously switched over to a screen saver screen, if screen saver processing is performed when a plurality of screens is being displayed. In consideration thereof, a technique has been developed for selectively applying a screen saver screen to a display window of an application that is not immediately required (for example, Japanese Patent Laid-Open No. 2007-316637 (Page 1, FIG. 1, and the like) or the like).

Moreover, a technique for controlling an activation timing of a screen saver and a technique for generating a screen saver screen by describing a screen saver function in a BML script language and interpreting and using the script language as an execution program, are known (for example, Japanese Patent Laid-Open No. 2005-094299 ([0024] to [0033], FIGS. 4 and 5, and the like), Japanese Patent Laid-Open No. 2004-015288 (Page 10, FIG. 1, and the like), and the like).

### SUMMARY OF INVENTION

### Problem to be Solved by the Invention

However, while the aforementioned Japanese Patent Laid-Open No. 2007-316637 (Page 1, FIG. 1, and the like), Japanese Patent Laid-Open No. 2005-094299 ([0024] to [0033], FIGS. 4 and 5, and the like), Japanese Patent Laid-Open No. 2004-015288 (Page 10, FIG. 1, and the like), and the like disclose mechanisms for activating and deactivating a screen saver, a control of activation and deactivation of a screen saver when a plurality of devices is connected as in a relationship between a server such as an HDD recorder and an image display device, is not taken into consideration.

With such a system, in a state where the HDD recorder and the image display device are connected to each other, an abrupt switchover of the image display device to a screen saver screen, may occur when a movie program stored in the HDD recorder is being reproduced and displayed on the image display device.

However, a screen saver is desirably generated and displayed in accordance with a state of the HDD recorder while a movie program of the HDD recorder is reproduced.

Control is desired such that when a server, including but not limited to an HDD recorder, is connected to an image display device and an image outputted from the server is being displayed on the image display device, a display screen is not abruptly switched over to a screen saver screen.

The present invention has been made in consideration of such problems existing in conventional servers and image display devices, and an object thereof is to provide an image display system, an image display device, a program, and a recording medium that reliably prevent a display screen of the image display device from being abruptly switched over to a screen saver screen at an inconvenient timing.

### Means for Solving Problem

The 1^{st} aspect of the present invention is an image display device comprising:

a stream processing unit that processes video stream information obtained from a server, to generate a video stream image;

a screen saver processing unit that has a screen saver timer and that generates a screen saver image using the screen saver timer;

an image output unit that outputs the video stream image and the screen saver image; and

an image control unit that resets the screen saver timer on a basis of a program obtained from the server, while the image output unit outputs the video stream image.

The 2^{nd} aspect of the present invention is the image display device according to the 1^{st} aspect of the present invention, wherein

an image control processing unit includes the image control unit and the stream processing unit,

the image control unit, based on the program obtained from the server, performs reset of the screen saver timer at a cycle Tr, using the image control unit's own timer, by transmitting to the screen saver processing unit a reset instruction for the screen saver timer as screen saver control information,

the image control unit suspends transmission of the screen saver control information to the screen saver processing unit in response to completion of reproduction by the stream processing unit, and

an operation of the screen saver timer in the screen saver processing unit follows the screen saver control information transmitted by the image control unit.

The 3^{rd} aspect of the present invention is an image display device comprising:

a stream processing unit that processes video stream information obtained from a server, to generate a video stream image;

a screen saver processing unit that has a screen saver timer and that generates a screen saver image using the screen saver timer;

an image output unit that outputs the video stream image and the screen saver image; and

an image control unit, wherein

the server transmits a timer reset message to the image control unit every predetermined cycle Tr by using the server's own timer,

the image control unit receives the timer reset message and, based on the timer reset message, transmits, to the screen saver processing unit, a reset instruction for the screen saver timer as the screen saver control information,

the image control unit transmits, in response to the completion of reproduction by the stream processing unit, a screen saver control completion message to the server,

the server suspends counting of the server's own timer and also suspends transmission of the timer reset message upon receiving the screen saver control completion message, and

the image control unit suspends, in response to the suspension of transmission of the timer reset message, transmission, to the screen saver processing unit, of the reset instruction for the screen saver timer as the screen saver control information.

The 4^{th} aspect of the present invention is an image system comprising a server that accumulates and transmits encoded video stream information and an image display device that obtains and decodes the video stream information from the server and outputs an image, wherein

the image display device includes:

a screen saver processing unit that has a first screen saver timer and that generates a screen saver image by using the first screen saver timer; and

an image control processing unit which includes an image control unit that has a second screen saver timer and that controls generation of the screen saver image in the screen saver processing unit, and a stream processing unit that processes the video stream information, wherein

the image control processing unit controls the second screen saver timer and the screen saver processing unit by using screen saver control information which is generated by the image control processing unit itself or obtained from the server and which controls the second screen saver timer and the screen saver processing unit,

an operation of the first screen saver timer of the screen saver processing unit is associated, via the screen saver control information, to a state of processing of the stream processing unit and is also associated to another predetermined event, and

an operation of the second screen saver timer is associated to a state of processing of the stream processing unit.

The 5^{th} aspect of the present invention is an image display device which obtains and decodes video stream information from a server that accumulates and transmits encoded video stream information, and which outputs an image, the image display device comprising:

a screen saver processing unit that has a first screen saver timer and that generates a screen saver image by using the first screen saver timer; and

an image control processing unit which includes an image control unit that has a second screen saver timer and that controls generation of the screen saver image in the screen saver processing unit, and a stream processing unit that processes the video stream information, wherein

the image control processing unit controls the second screen saver timer and the screen saver processing unit by using screen saver control information which is generated by the image control processing unit itself or obtained from the server and which controls the second screen saver timer and the screen saver processing unit,

an operation of the first screen saver timer of the screen saver processing unit is associated, via the screen saver control information, to a state of processing of the stream processing unit and is also associated to another predetermined event, and

an operation of the second screen saver timer is associated to a state of processing of the stream processing unit.

The 6^{th} aspect of the present invention is the image display device according to the 5^{th} aspect of the present invention, wherein

the first screen saver timer interrupts operation at least during image reproduction by the stream processing unit and restarts the operation due to an image reproduction completion notification that is the screen saver control information.

The 7^{th} aspect of the present invention is the image display device according to the 6^{th} aspect of the present invention, wherein

the image control unit receives a program from the server, and based on the program, performs reset of the second screen saver time at a cycle Tr, by issuing, to the image control unit's own second screen saver timer, a reset instruction as the screen saver control information, and

according to the image reproduction completion notification from the stream processing unit, the image control unit suspends the reset instruction to the second screen saver timer and causes the first screen saver timer to restart operation.

The 8^{th} aspect of the present invention is the image display device according to the 6^{th} aspect of the present invention, wherein

the image control unit receives a program from the server, and based on the program, performs reset of the second screen saver timer which is generated from the second screen saver timer program obtained from the server, at a cycle Tr, by issuing, to the second screen saver timer, a reset instruction as the screen saver control information, and

according to the image reproduction completion notification from the stream processing unit, the image control unit suspends the reset instruction to the second screen saver timer and causes the first screen saver timer to restart operation.

The 9^{th} aspect of the present invention is the image display device according to the 6^{th} aspect of the present invention, wherein

the server transmits a timer reset message to the image control unit every predetermined cycle Tr by using the server's own timer,

the image control unit receives the timer reset message and, based on the timer reset message, issues a reset instruction, as the screen saver control information, to the second screen saver timer so as to perform reset of the second screen saver timer,

the image control unit suspends the reset instruction to the second screen saver timer and causes the first screen saver timer to restart operation, in response to the image reproduction completion notification from the stream processing unit,

the image control unit transmits, in response to the image reproduction completion notification from the stream processing unit, a screen saver control completion message to the server, and

the server suspends counting of the server's own timer and also suspends transmission of the timer reset message, upon receiving the screen saver control completion message.

The 10^{th} aspect of the present invention is the image display device according to the 5^{th} aspect of the present invention, wherein

the other predetermined event is an event for executing predetermined application processing other than image reproduction of the video stream information.

The 11^{th} aspect of the present invention is a non-transitory computer-readable medium having a program stored thereon, wherein the program causes a computer to operate as:

the screen saver processing unit that has the first screen saver timer and that generates a screen saver image by using the first screen saver timer; and

the image control processing unit which includes the image control unit that has the second screen saver timer and that controls generation of the screen saver image in the screen saver processing unit, and the stream processing unit that processes the video stream information,

of the image display device according to the fifth aspect of the present invention.

The 12^{th} aspect of the present invention is an image system comprising a server that accumulates and transmits encoded video stream information and an image display device that obtains and decodes the video stream information from the server and outputs an image, wherein

the image display device includes:

a screen saver processing unit that has a first screen saver timer; and

an image control processing unit which includes a rendering unit that generates a screen saver image, an image control unit that has a second screen saver timer and controls the rendering unit, and a stream processing unit that processes the video stream information, wherein

the image control processing unit controls the second screen saver timer by using screen saver control information which is generated by the image control processing unit itself or obtained from the server and which controls the second screen saver timer, and

the second screen saver timer is associated to a state of processing of the stream processing unit via the screen saver control information.

The 13^{th} aspect of the present invention is an image display device that obtains and decodes video stream information from a server that accumulates and transmits encoded video stream information and which outputs an image, the image display device comprising:

a screen saver processing unit that has a first screen saver timer; and

an image control processing unit which includes a rendering unit that generates a screen saver image, an image control unit that has a second screen saver timer and controls the rendering unit, and a stream processing unit that processes the video stream information, wherein

the image control processing unit controls the second screen saver timer by using screen saver control information which is generated by the image control processing unit itself or obtained from the server and which controls the second screen saver timer, and

the second screen saver timer is associated to a state of processing of the stream processing unit via the screen saver control information.

The 14^{th} aspect of the present invention is an image display device that obtains and decodes video stream information from a server that accumulates and transmits encoded video stream information and which outputs an image, the image display device comprising:

a screen saver processing unit that has a rendering unit generating a screen saver image and a first screen saver timer; and

an image control processing unit which includes an image control unit that has a second screen saver timer and controls the rendering unit, and a stream processing unit that processes the video stream information, wherein

the image control processing unit controls the second screen saver timer by using screen saver control information which is generated by the image control processing unit itself or obtained from the server and which controls the second screen saver timer, and

the second screen saver timer is associated to a state of processing of the stream processing unit via the screen saver control information.

The 15^{th} aspect of the present invention is the image display device according to the 13^{th} aspect of the present invention, wherein

the first screen saver timer interrupts operation at least during image reproduction by the stream processing unit and the second screen saver timer restarts operation after the completion of image reproduction.

The 16^{th} aspect of the present invention is the image display device according to the 15^{th} aspect of the present invention, wherein

the image control unit receives a program from the server, and based on the program, performs reset of the second screen saver timer at a cycle Tr by issuing, to the image control unit's own second screen saver timer, a reset instruction as the screen saver control information, and

according to an image reproduction completion notification from the stream processing unit, the image control unit suspends the reset instruction to the second screen saver timer and controls the rendering unit based on counting of the second screen saver timer.

The 17^{th} aspect of the present invention is the image display device according to the 15^{th} aspect of the present invention, wherein

the image control unit receives a program from the server, and based on the program, performs reset of the second screen saver timer which is generated from the second screen saver timer program obtained from the server, at a cycle Tr by issuing, to the second screen saver timer, a reset instruction as the screen saver control information, and

according to an image reproduction completion notification from the stream processing unit, the image control unit suspends the reset instruction to the second screen saver timer and controls the rendering unit based on counting of the second screen saver timer.

The 18^{th} aspect of the present invention is the image display device according to the 15^{th} aspect of the present invention, wherein

the server transmits a timer reset message to the image control unit every predetermined cycle Tr by using the server's own timer,

the image control unit receives the timer reset message and, based on the timer reset message, issues a reset instruction, as the screen saver control information, to the second screen saver timer and performs reset of the second screen saver timer,

the image control unit suspends the reset instruction to the second screen saver timer and controls the rendering unit, based on counting of the second screen saver timer in response to an image reproduction completion notification from the stream processing unit,

the image control unit transmits, in response to the image reproduction completion notification from the stream processing unit, a screen saver control completion message to the server, and

the server suspends counting of the server's own timer and also suspends transmission of the timer reset message upon receiving the screen saver control completion message.

The 19^{th} aspect of the present invention is the image display device according to the 13^{th} aspect of the present invention, wherein

the other predetermined event is an event for executing predetermined application processing other than image reproduction of the video stream information.

The 20^{th} aspect of the present invention is a non-transitory computer-readable medium having a program stored thereon, wherein the program causes a computer to operate as:

the screen saver processing unit that has the first screen saver timer and that generates a screen saver image by using the first screen saver timer; and

the image control processing unit that has the rendering unit which generates the screen saver image, the image control unit which has the second screen saver timer, controls the rendering unit and controls the screen saver processing unit, and the stream processing unit which processes the video stream information,

of the image display device according to the 13^{th} aspect of the present invention.

The 21^{st} aspect of the present invention is the image display device according to the 3^{rd} aspect of the present invention, wherein

the server executes a program in a script format that controls a timing of a generation start time of a screen saver screen.

### Advantages of the Invention

According to the present invention, under such state where a plurality of devices are connected, an activation of a screen saver function without consideration of condition of one device, can be prevented

### BRIEF DESCRIPTION OF DRAWINGS

FIG. 1 is a block diagram of a screen saver control system according to a first embodiment of the present invention.

FIG. 2 is a processing sequence (A) diagram of the screen saver control system according to the first embodiment of the present invention.

FIG. 3 is a block diagram of a screen saver control system according to a second embodiment of the present invention.

FIG. 4 is a processing sequence (B) diagram of the screen saver control system according to the second embodiment of the present invention.

FIG. 5 is a block diagram of a screen saver control system according to a third embodiment of the present invention.

FIG. 6 is a processing sequence (C) diagram of the screen saver control system according to the third embodiment of the present invention.

FIG. 7 is a block diagram of a screen saver control system according to a fourth embodiment of the present invention.

FIG. 8 is a processing sequence (D) diagram of the screen saver control system according to the fourth embodiment of the present invention.

FIG. 9 is a block diagram of a screen saver control system according to a fifth embodiment of the present invention.

FIG. 10 is a processing sequence (E) diagram of the screen saver control system according to the fifth embodiment of the present invention.

FIG. 11 is a block diagram of a screen saver control system according to a sixth embodiment of the present invention.

FIG. 12 is a processing sequence (F) diagram of the screen saver control system according to the sixth embodiment of the present invention.

FIG. 13 is a flow chart of script processing and timer processing by a screen saver control system according to an embodiment of the present invention.

FIG. 14 is another flow chart of script processing and timer processing by a screen saver control system according to an embodiment of the present invention.

### EMBODIMENTS OF THE INVENTION

Embodiments of an image display system, an image display device, a program, and a recording medium according to the present invention will now be described with reference to the drawings. It should be noted that when components denoted by the same reference numerals perform similar operations in the respective embodiments, repetitive descriptions of such components will be omitted.

### First Embodiment

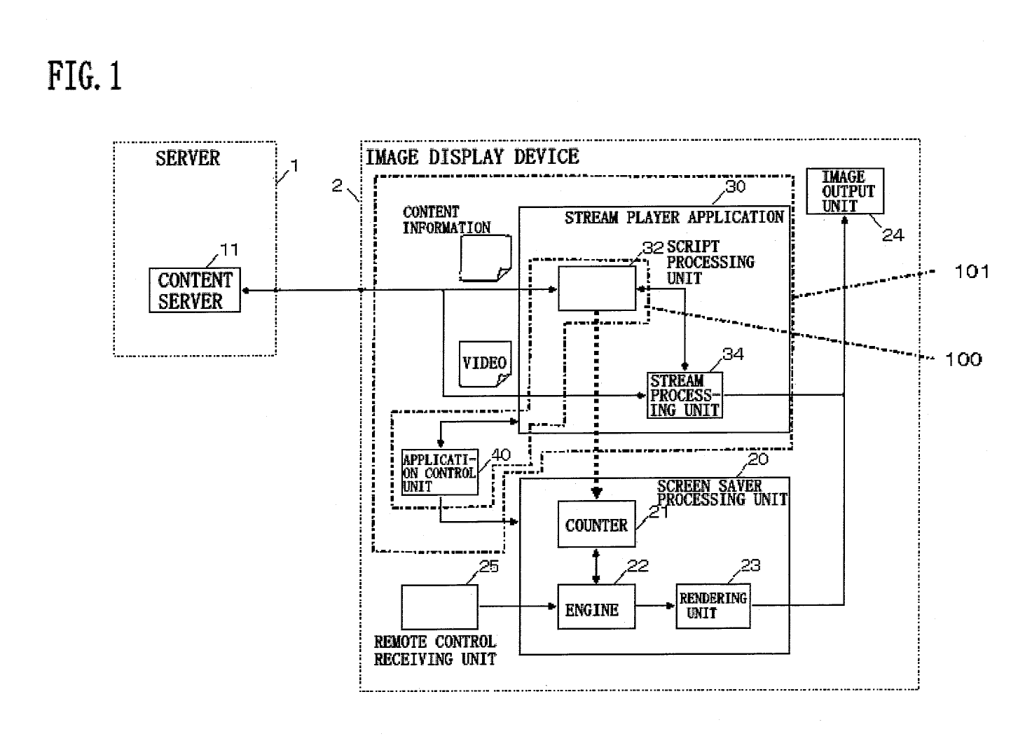

FIG. 1 illustrates a configuration example of an image display system and an image display device according to the present invention. In FIG. 1, a present first embodiment includes a server 1 and an image display device 2. A feature of the present first embodiment is that the image display device 2 acquires screen saver control information from the server 1 and controls a generation timing of a screen saver screen.

The server 1 includes a content server 11. The content server 11 stores video stream information of image programs such as movies and news. In addition, the content server 11 stores, in JavaScript (registered trademark), information regarding suspension/activation and operation contents of a screen saver, and information necessary for rendering when an application is activated by the image display device 2.

The image display device 2 includes a screen saver processing unit 20, a stream player application 30, an image output unit 24, a remote control receiving unit 25, and an application control unit 40.

The screen saver processing unit 20 includes a counter 21, an engine 22, and a rendering unit 23, and outputs a screen saver image under a predetermined condition. The counter 21 includes a screen saver timer and is a counting unit that counts a time Ts. Ts may either be information representing time or information of a numerical value corresponding to time. The engine 22 is a computing unit that generates a screen saver image. The rendering unit 23 is an image generating unit that generates a screen saver image based on computation results of the engine 22.

The stream player application 30 includes a script processing unit 32 and a stream processing unit 34. The script processing unit 32 is a script executing unit that executes content information described in JavaScript (registered trademark). The stream processing unit 34 is a unit that decodes and converts video stream information received from the content server 11 into video image information.

The image output unit 24 is a display unit that displays an image such as video image information and a screen saver image. The image output unit 24 is a unit that outputs an image decoded by the stream processing unit 34 or, when the screen saver image is generated and outputted by the screen saver processing unit 20, outputs the screen saver image. In other words, when the rendering unit 23 generates and outputs a screen saver image, the image output unit 24 outputs the screen saver image.

Moreover, the image display device 2 includes functions for television broadcast reception, channel selection, television program display, and for displaying arbitrary text information or video information.

Reference numeral 100 denotes an image control unit according to the present invention and includes the script processing unit 32 and the application control unit 40.

In addition, reference numeral 101 denotes an image control processing unit according to the present invention and includes the image control unit 100 and the stream processing unit 34.

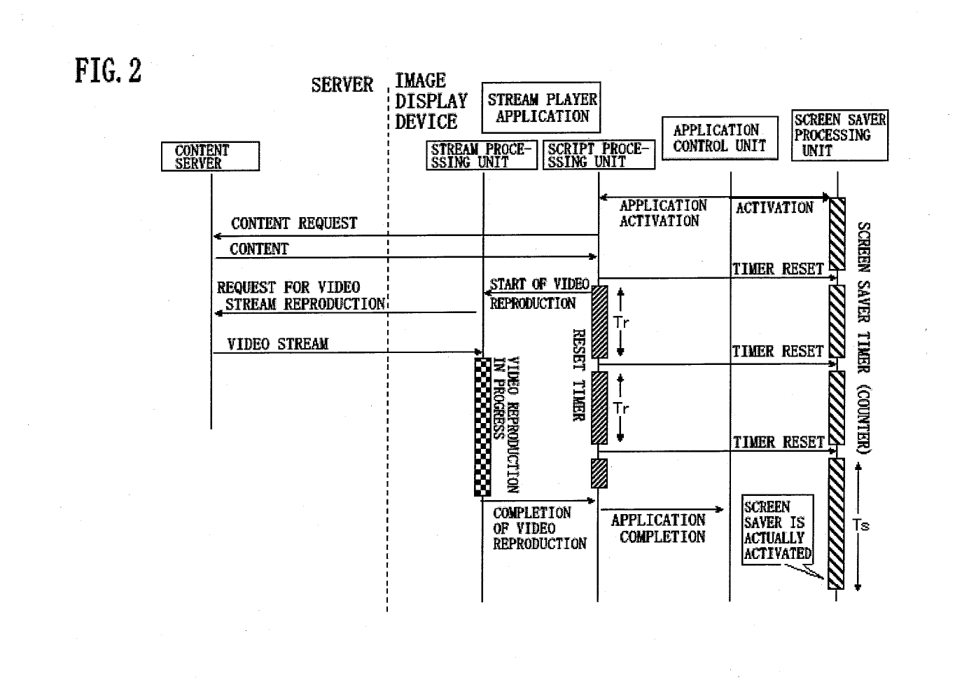

Next, operations of the present first embodiment will be described with reference to the sequence (A) diagram illustrated in FIG. 2.

The application control unit 40 is equipped with a function for controlling operations of the stream player application 30. When a user issues a video reproduction instruction, the application control unit 40 issues an application activation instruction to the stream player application 30. As a result, the script processing unit 32 of the stream player application 30 makes a content request to the content server 11.

It is assumed that the screen saver processing unit 20 has been activated upon activation of the image display device 2 and has started counting. The counter 21 of the screen saver processing unit 20 is a counter arranged so as to cause a screen saver screen to be generated and to be outputted when the counting result reaches a predetermined time Ts.

Upon receiving the content request, the content server 11 supplies content information to the stream player application 30. The script processing unit 32 receives the content information and interprets the script using an interpreting unit built into the script processing unit 32. Content information includes a description of a program for outputting a timer reset at a predetermined cycle Tr (where Tr<Ts).

When the script processing unit 32 interprets and executes the program for outputting a timer reset at the predetermined cycle Tr, the script processing unit 32 outputs the timer reset to the counter 21. The timer reset is a signal that instructs the counter 21 to reset counting, and represents an example of screen saver control information according to the present invention.

According to the content information, the script processing unit 32 outputs a timer reset using a reset timer included in the script processing unit 32. That is, whenever the predetermined time count value Tr (where Tr<Ts) is reached, the script processing unit 32 issues a timer reset instruction to the counter 21. As described above, since the script processing unit 32 performs a timer reset of the counter 21 whenever the reset timer reaches the count value Tr, generation of a screen saver screen is postponed each time a timer reset occurs.

Next, the script processing unit 32 issues instruction information for starting video reproduction to the stream processing unit 34. According to the instruction, the stream processing unit 34 makes a video stream reproduction request to the content server 11. The content server 11 supplies the requested video stream to the stream processing unit 34. The stream processing unit 34 decodes the received video stream and supplies a video image to the image output unit 24.

Finally, when reproduction of a video stream is completed at the stream processing unit 34, the stream processing unit 34 notifies the completion of reproduction to the script processing unit 32. Upon receiving the notice, the script processing unit 32 suspends counting of its own reset timer and, at the same time, notifies completion of the stream player application to the application control unit 40.

When counting by the reset timer is suspended as described above, a timer reset from the script processing unit 32 does not occur and a count value of the counter 21 increases. Therefore, when the count value of the counter 21 reaches Ts, the counter 21 activates the engine 22 for generating a screen saver image, and the rendering unit 23 renders a predetermined screen saver screen and supplies the rendered screen saver screen to the image output unit 24. When a screen saver image signal is outputted from the rendering unit 23, the image output unit 24 displays a screen saver image.

A feature of the present first embodiment is that instead of controlling a generation start time of a screen saver screen by an application itself of the screen saver processing unit 20 built into the image display device 2, the counter 21 is reset from a stream player application 30 that is an application outside of the screen saver processing unit 20.

Moreover, the remote control receiving unit 25 is a device which receives operations performed by a remote controller that is a unit which controls and executes other application functions (for example, functions for television broadcast reception, channel selection, television program display, and displaying arbitrary text information or video information) of the present image display device 2. When an operation signal (corresponding to another event according to the present invention) of the remote controller is inputted to the remote control receiving unit 25, the remote control receiving unit 25 is arranged so as to reset a count up of the counter 21.

In the sequence described above, screen saver control information for controlling the screen saver processing unit 20 is generated from content information. Specifically, when a program in a script format that is content information is executed by the script processing unit 32, screen saver control information or, in other words, timer reset information is generated, in which case the screen saver control information initializes the count value of the counter 21 and activates a count operation. A dashed line that extends from the script processing unit 32 to the counter 21 in FIG. 1 indicates a flow of screen saver control information. Therefore, screen saver control information is program processing information for initializing the counter at a predetermined cycle. Processing procedures such as the program processing above will now be described with greater specificity.

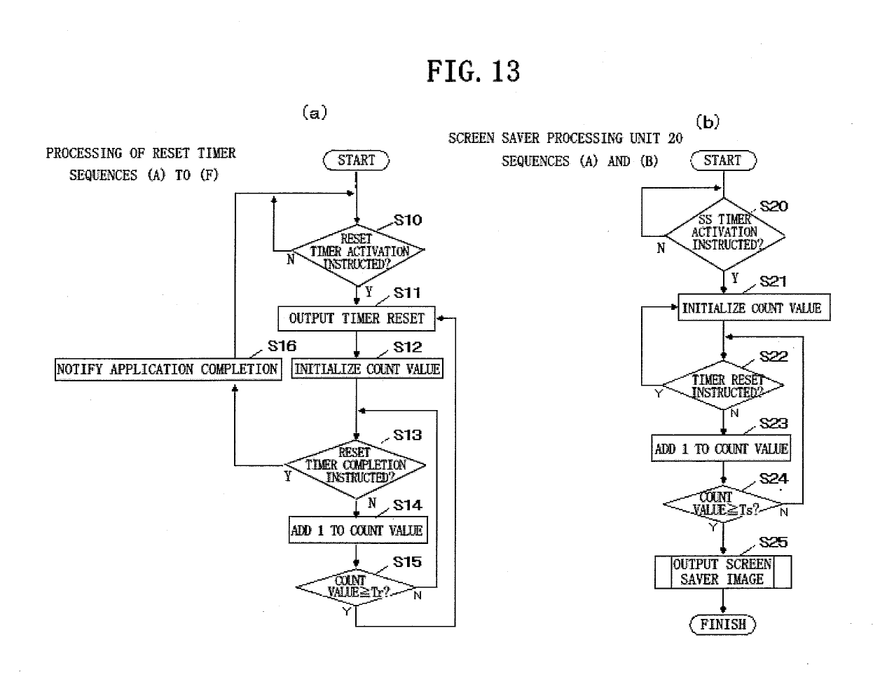

FIG. 13(a) is a flow chart illustrating a program for reset timer processing performed by the script processing unit 32. In step S10 in FIG. 13(a), a program of the script processing unit 32 awaits a reset timer activation instruction based on an application activation from the application control unit 40.

When a reset timer activation instruction is issued in step S10 and a Yes result is obtained, the script processing unit 32 proceeds to step S11 to output a timer reset instruction to the counter 21 of the screen saver processing unit 20, and proceeds to step S12. In step S12, the script processing unit 32 initializes a count value of its own reset timer.

Next, the script processing unit 32 proceeds to step S13 and checks whether or not an instruction for completing a timer operation of the reset timer has been issued. In this case, an instruction for completing the reset timer refers to a video reproduction completion notification to be issued by the stream processing unit 34. When a video reproduction completion notification has not yet been issued, a No result is obtained in step S13 and the script processing unit 32 proceeds to step S14.

In step S14, the script processing unit 32 increases the count value of the reset timer by 1, and proceeds to step S15 to judge whether or not the count value has reached Tr. When Tr has not yet been reached and step S15 results in No, the script processing unit 32 returns to step S13. When step S15 results in Yes, the script processing unit 32 returns to step S11 to output a timer reset instruction and continues reset timer processing.

Moreover, when a Yes result of step S13 is obtained by a notification of video reproduction completion and an issue of a reset timer completion instruction, it means that the notification of video reproduction completion has occurred, and therefore in step S16, the script processing unit 32 notifies application completion to the application control unit 40. The script processing unit 32 then returns to step S10 to suspend reset timer processing and await a next reset timer activation instruction.

Content information according to the present first embodiment is a program that describes such processing procedures illustrated in the flow chart in a script format.

FIG. 13(b) is a flow chart illustrating operations by the screen saver processing unit 20. In step S20, the screen saver processing unit 20 awaits an instruction for screen saver timer activation. An instruction for screen saver timer activation refers to an instruction for starting a screen saver which is issued from the application control unit 40 and which has been described with reference to the sequence chart illustrated in FIG. 2. Specifically, the instruction is for the counter 21 to start counting. When step S20 results in Yes, the screen saver processing unit 20 proceeds to step S21 and initializes a count value of the screen saver timer of the counter 21.

Next, the screen saver processing unit 20 proceeds to step S22 and checks whether or not a timer reset has been issued by the script processing unit 32. When step S22 results in Yes, the screen saver processing unit 20 returns to step S21. When step S22 results in No, the screen saver processing unit 20 proceeds to step S23 and increases the count value of the screen saver timer by 1.

Next, the screen saver processing unit 20 proceeds to step S24 and checks whether the count value has reached Ts or not. When step S24 results in No, the screen saver processing unit 20 returns to step S22 to continue counting. When step S24 results in Yes, the screen saver processing unit 20 proceeds to step S25 and activates the engine 22 and the rendering unit 23 to start generation and output of a screen saver image.

In this manner, when a predetermined condition such as the condition indicated by the flow chart described above is satisfied, the screen saver processing unit 20 is to output a screen saver image in step S25.

While an example where timer reset information is used as the screen saver control information, has been described above, the screen saver control information can be information other than timer reset information as long as such information controls activation of processing for generating a screen saver image.

### Second Embodiment

Next, an example of a configuration of a second embodiment according to the present invention arranged such that an image display device 2 internally stores content information and a server 1 performs a part of processing of the content information, will be described with a focus on portions that differ from the first embodiment.

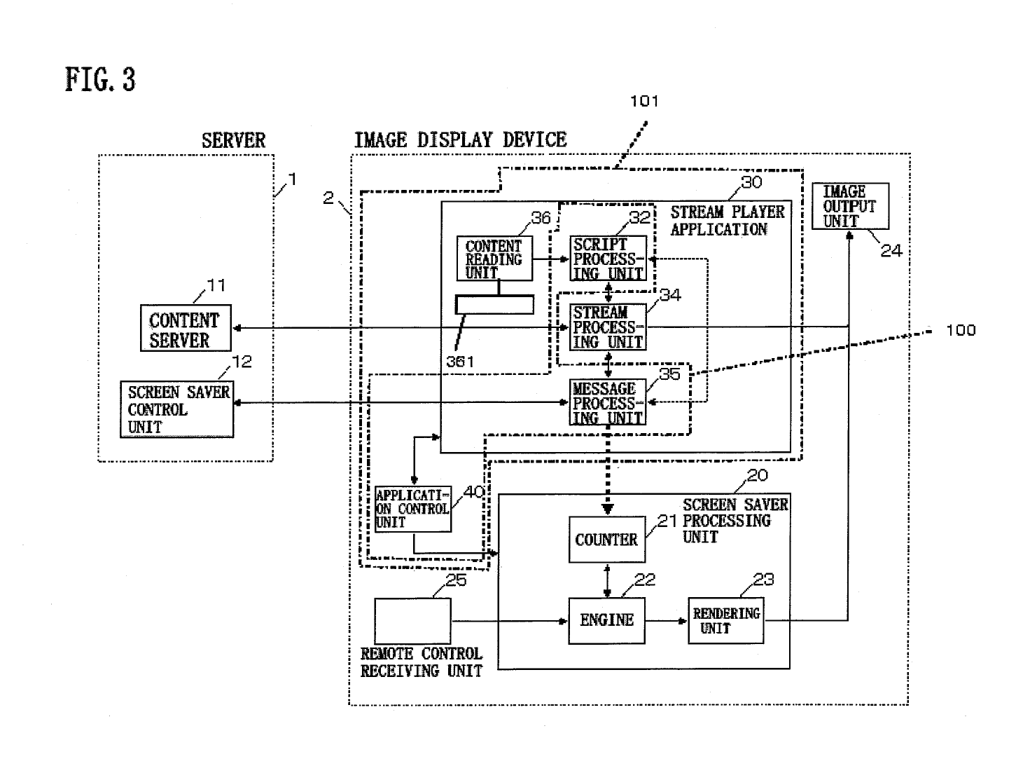

FIG. 3 illustrates a configuration of the second embodiment according to the present invention. In FIG. 3, a system according to the present second embodiment includes a server 1 and an image display device 2.

The server 1 includes a content server 11 and a screen saver control unit 12. The content server 11 stores video stream information of image programs such as movies and news. The screen saver control unit 12 executes a part of processing related to the control of a start time of screen saver screen generation to be performed in the image display device 2. More specifically, the screen saver control unit 12 itself includes a reset timer and performs counting of the reset timer and generation of a timer reset message. The timer reset message is a message which instructs that a timer reset information for resetting a counter 21 is to be supplied to the counter 21. To this end, the screen saver control unit 12 has a built-in program which is described in a script format and which controls a generation timing of a screen saver. The timer reset information is an example of screen saver control information.

The image display device 2 includes a screen saver processing unit 20, a stream player application 30, an image output unit 24, a remote control receiving unit 25, and an application control unit 40. As described in the first embodiment, the screen saver processing unit 20 is made up of the counter 21, an engine 22, and a rendering unit 23. The stream player application 30 includes a script processing unit 32, a stream processing unit 34, a message processing unit 35, and a content reading unit 36. The content storage unit 361 stores content information which is an operation procedure in a script format related to screen saver control.

The message processing unit 35 generates a predetermined message based on an instruction from the application control unit 40, and transmits/receives a message among the screen saver control unit 12 and the stream processing unit 34.

Moreover, the image display device 2 includes functions for television broadcast reception, channel selection, television program display, and for displaying arbitrary text information or video information.

Here, reference numeral 100 denotes an image control unit according to the present invention and includes the script processing unit 32, the message processing unit 35, and the application control unit 40.

In addition, reference numeral 101 denotes an image control processing unit according to the present invention and includes the image control unit 100 and the stream processing unit 34.

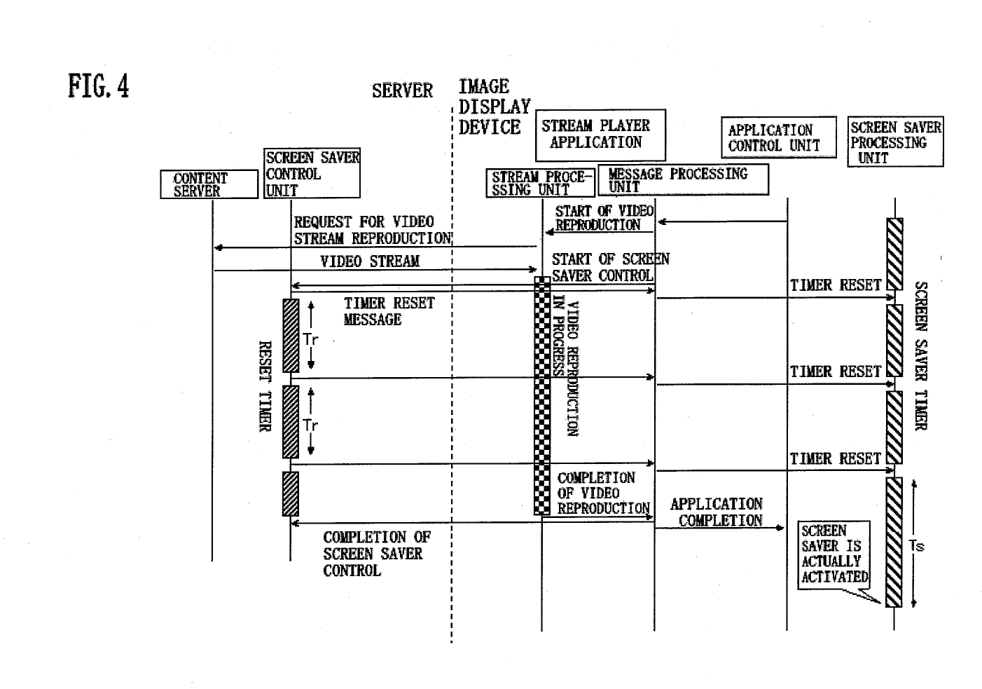

Next, operations of the present second embodiment will be described with reference to the sequence (B) diagram illustrated in FIG. 4.

The application control unit 40 is equipped with a function for controlling operations of the stream player application 30. When a user issues a video reproduction instruction, the application control unit 40 issues an application activation instruction to the stream player application 30. As a result, the message processing unit 35 of the stream player application 30 issues an instruction for starting video reproduction to the stream processing unit 34. Based on the instruction for starting video reproduction, the stream processing unit 34 makes a video stream reproduction request to the content server 11. It is assumed that the screen saver processing unit 20 has been activated upon activation of the image display device 2. In addition, the counter 21 of the screen saver processing unit 20 is a counter that counts a predetermined time Ts until a screen saver screen is outputted.

Furthermore, based on the instruction for application activation, the message processing unit 35 sends an instruction message for starting screen saver control to the screen saver control unit 12 of the server 1.

Based on the instruction message for starting screen saver control, the screen saver control unit 12 sends a timer reset message to the message processing unit 35 and activates counting by its own reset timer provided in the screen saver control unit 12.

The message processing unit 35 having received the timer reset message instructs a timer reset to the counter 21 of the screen saver processing unit 20 and causes the counting of the screen saver timer of the counter 21 to be reactivated all over again.

Based on the video stream reproduction request, the content server 11 transmits a video stream to the stream processing unit 34. The stream processing unit 34 receives the video stream, performs video reproduction, and enters a “video reproduction in progress” state.

On the other hand, the reset timer of the screen saver control unit 12 transmits a timer reset message to the message processing unit 35 every time the count value reaches Tr (where Tr<Ts). Upon receiving the timer reset message, the message processing unit 35 instructs timer reset to the counter 21 of the screen saver processing unit 20 and causes the counting by the screen saver timer of the counter 21 to be reactivated all over again. Therefore, the generation of a screen saver image is to be postponed each time.

Finally, when reproduction of a video stream is completed at the stream processing unit 34, the stream processing unit 34 notifies the completion of reproduction to the message processing unit 35. Upon receiving the notification, the message processing unit 35 transmits a screen saver control completion message to the screen saver control unit 12 of the server 1.

Upon receiving the screen saver control completion message, the screen saver control unit 12 suspends counting of its own reset timer. As a result, the count value no longer reaches Tr, a timer reset message is no longer sent to the message processing unit 35 and, therefore, the message processing unit 35 no longer instructs timer reset to the counter 21.

In addition, the message processing unit 35 notifies the application control unit 40 that the reproduction application for the video stream has been completed.

Consequently, since timer reset is not instructed to the counter 21 that is a screen saver timer, from the message processing unit 35, the count value of the counter 21 continues increasing over Tr and reaches Ts. As a result, the counter 21 activates the engine 22 that generates a screen saver image, the rendering unit 23 renders a predetermined screen saver screen and the rendered screen saver screen is supplied to the image output unit 24.

A feature of the present second embodiment is that instead of controlling a generation start time of a screen saver screen by an application itself of the screen saver processing unit 20 built into the image display device 2, the counter 21 is reset from a stream player application 30 that is an application outside of the screen saver processing unit 20, based on an operation of the reset timer of the screen saver control unit 12 of the server 1.

The present second embodiment is convenient in that the same server 1 handles both an image stream and a screen saver control script.

Moreover, functions of the screen saver control unit 12 need not necessarily include a script processing type function.

In addition, while the screen saver control unit 12 is assumed to be provided in the server 1 in advance in the above description, the script processing unit 32 may be arranged so as to read, via the content reading unit 36, a script format program which controls a generation timing of a screen saver and which is a processing content of the screen saver control unit 12, and to transmit and supply the program to the screen saver control unit 12.

That is, the content reading unit 36 may be arranged so as to read content information which is stored in a content storage unit 361 in the image display device 2 and which is an operation procedure in a script format related to screen saver control, and to supply the content information to the script processing unit 32. The content information includes a description of a program for outputting a timer reset at a predetermined cycle Tr.

Moreover, the description of the present modification provides that an operation procedure related to screen saver control is stored in a script format in the content storage unit 361 as content information to be read by the content reading unit 36, and contents thereof are to be interpreted by the script processing unit 32 and supplied to the message processing unit 35 and the stream processing unit 34. But the operation procedure related to screen saver control at the message processing unit 35 and the stream processing unit 34 may alternatively be incorporated in advance into the message processing unit 35 and the stream processing unit 34.

Furthermore, an example in which the reset timer of the screen saver control unit 12 issues a timer reset message has been described above. Since a timer reset message temporarily delays generation of a screen saver image, a timer reset message can have meaning of a screen saver prohibition message. In a case of a configuration in which, for example, the screen saver processing unit 20 starts rendering of a screen saver image directly under an operation start instruction from the engine 22 without using the counter 21, generation and pause of generation of a screen saver image may be controlled by the screen saver prohibition message.

The screen saver prohibition message of screen saver image generation can alternatively be arranged to be issued by an arbitrary event instead in response to counting by the reset timer of the screen saver control unit 12. Such events may include reproduction or suspension of an image stream and switching over of images.

Content information is a processing program or the like which is related to suspension/activation or an operation content of a screen saver and which is described in a script language. As for a reset timer function, a program of content information described in JavaScript (registered trademark) based on the flow chart of the reset timer illustrated in FIG. 13(a) can be applied.

In addition, the screen saver processing unit 20 may operate according to processing procedures of the flow chart illustrated in FIG. 13(b).

The above description provides that the message processing unit 35 transmits a message for starting screen saver control to the screen saver control unit 12 based on an application activation instruction of the application control unit 40, and upon receiving a timer reset message, the message processing unit 35 instructs timer reset to the counter 21. However, the following arrangement may alternatively be adopted.

The application control unit 40 issues an application activation instruction to the script processing unit 32, and the script processing unit 32 instructs the message processing unit 35 to generate and transmit a message for starting screen saver control. Based on the instruction from the script processing unit 32, the message processing unit 35 transmits a message for starting screen saver control to the screen saver control unit 12. Upon receiving a timer reset message, the message processing unit 35 notifies reception of a timer reset message to the script processing unit 32, in which case the script processing unit 32 instructs timer reset to the counter 21 according to the timer reset message or, in other words, the screen saver control information. Furthermore, the message processing unit 35 may also be configured as a part of the script processing unit 32.

### Third Embodiment

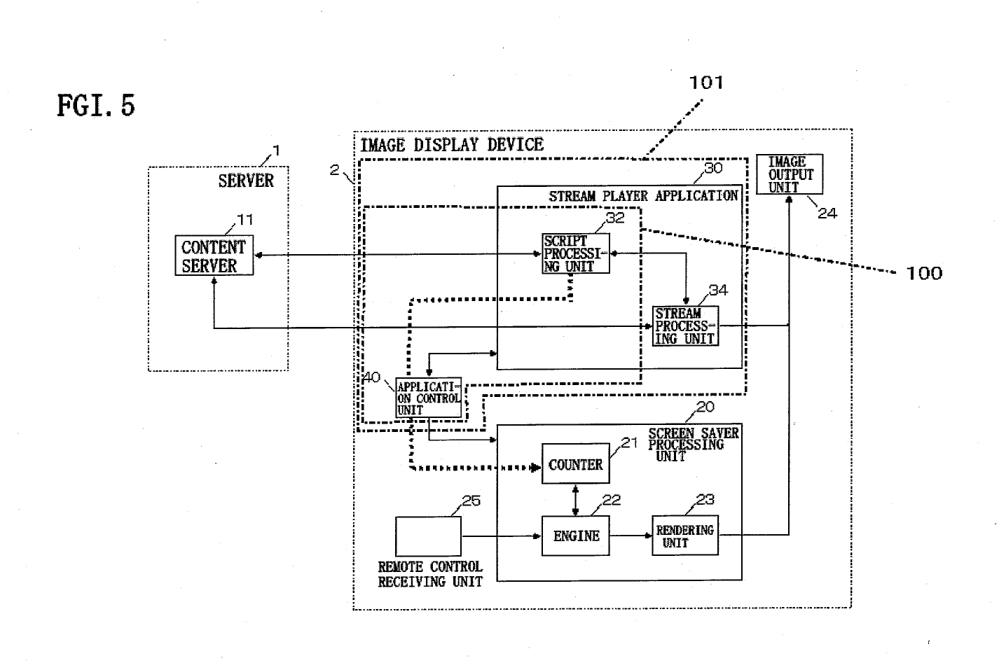

Next, FIG. 5 illustrates an example of a configuration of a system in which, on the premise that a timer operation of a screen saver processing unit is to be initially interrupted (including non-activation), an image display device 2 acquires a script for screen saver control from a server 1 and, based on the script, the image display device 2 performs screen saver control. The description below will focus on portions that differ from the first embodiment and the second embodiment.

The server 1 includes a content server 11. The content server 11 stores video stream information of an image program such as a movie or news and content information regarding suspension/activation or an operation content of a screen saver.

The image display device 2 includes a screen saver processing unit 20, a stream player application 30, an image output unit 24, a remote control receiving unit 25, and an application control unit 40. The screen saver processing unit 20 includes a counter 21, an engine 22, and a rendering unit 23. The stream player application 30 includes a script processing unit 32 and a stream processing unit 34. While the aforementioned components are similar to those already described in the first embodiment, parts of operations of the components differ as will be described later.

The application control unit 40 controls various functions of the respective parts of the image display device 2. However, in the present third embodiment, the application control unit 40 performs the following control on at least the stream player application 30 and the screen saver processing unit 20.

Here, reference numeral 100 denotes an image control unit according to the present invention and includes the script processing unit 32 and the application control unit 40.

In addition, reference numeral 101 denotes an image control processing unit according to the present invention and includes the image control unit 100 and the stream processing unit 34.

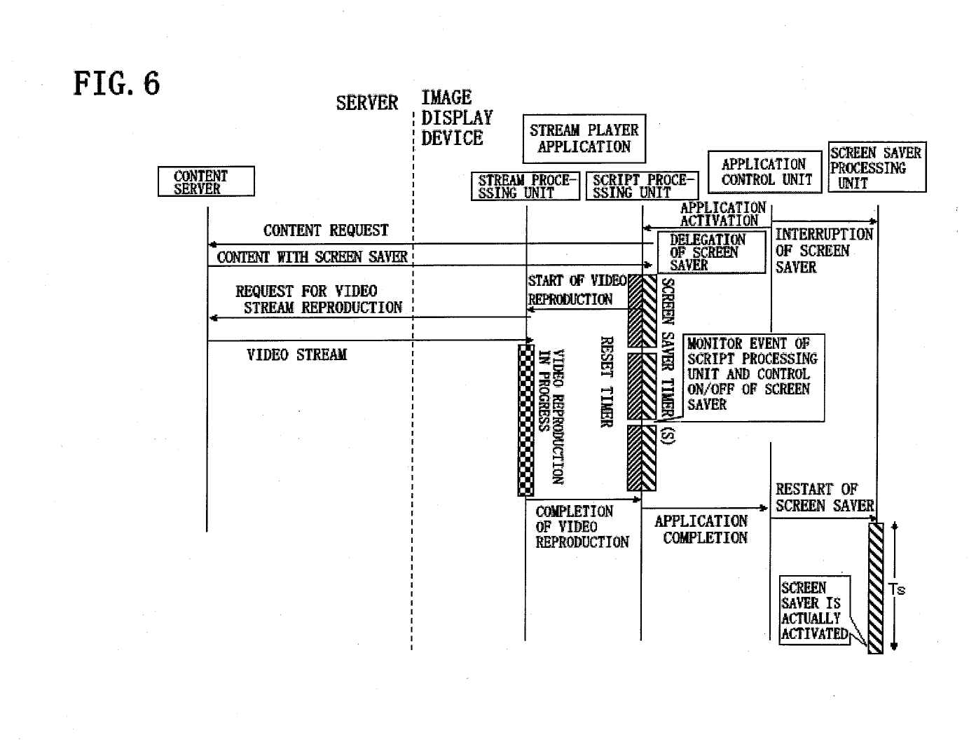

Next, operations of the present third embodiment will be described with reference to the sequence (C) diagram illustrated in FIG. 6.

The application control unit 40 is equipped with a function for controlling operations of the stream player application 30. When a user issues a video reproduction instruction, the application control unit 40 issues an application activation instruction to the stream player application 30. As a result, the script processing unit 32 of the stream player application 30 makes a content request to the content server 11. Moreover, in advance, the application control unit 40 suspends the counter 21 of the screen saver processing unit 20 and interrupts counting by the screen saver timer.

Upon receiving the content request, the content server 11 supplies content information with a screen saver to the stream player application 30. Content information without a screen saver may also be supplied. The script processing unit 32 receives the content information and interprets the content thereof using an interpreting unit built into the script processing unit 32. First, the script processing unit 32 activates a screen saver timer (S) and a reset timer contained in the content information. When the reset timer reaches a predetermined time count value Tr (where Tr<Ts), the script processing unit 32 performs timer reset on the screen saver timer (S). Since the script processing unit 32 performs a timer reset on the screen saver timer (S) whenever the reset timer reaches the count value Tr, the screen saver timer (S) does not reach a count value Ts. The screen saver timer (S) is a software timer expressed in a script language and is a designation used for distinguishing from the screen saver timer of the counter 21.

Moreover, in a case of content information without a screen saver, the script processing unit 32 must be provided in advance with a second screen saver timer.

Next, the script processing unit 32 issues instruction information for starting video reproduction to the stream processing unit 34. According to the instruction, the stream processing unit 34 makes a video stream reproduction request to the content server 11. The content server 11 supplies the requested video stream to the stream processing unit 34. The stream processing unit 34 decodes the received video stream and supplies a video image to the image output unit 24.

When reproduction of a video stream is completed at the stream processing unit 34, the stream processing unit 34 notifies the completion of video reproduction to the script processing unit 32. Upon receiving the notice, the script processing unit 32 suspends counting by the screen saver timer (S) and by the reset timer and, at the same time, notifies completion of the stream player application to the application control unit 40.

Upon receiving a notification of completion of the stream player application, the application control unit 40 instructs the screen saver processing unit 20 to restart a screen saver. In other words, the counting by the counter 21 is restarted. Once the count value of the counter 21 reaches Ts, the counter 21 activates the engine 22 that generates a screen saver image, and a predetermined screen saver screen is rendered at the rendering unit 23, and the rendered screen saver screen is supplied to the image output unit 24. Thereafter, the image output unit 24 displays a screen saver screen.

Content information is a processing program or the like which is related to suspension/activation or an operation content of a screen saver and which is described in a script language. As for the counting function of the reset timer, a program describing processing procedures of the flow chart illustrated in FIG. 13(a) in JavaScript (registered trademark) can be applied.

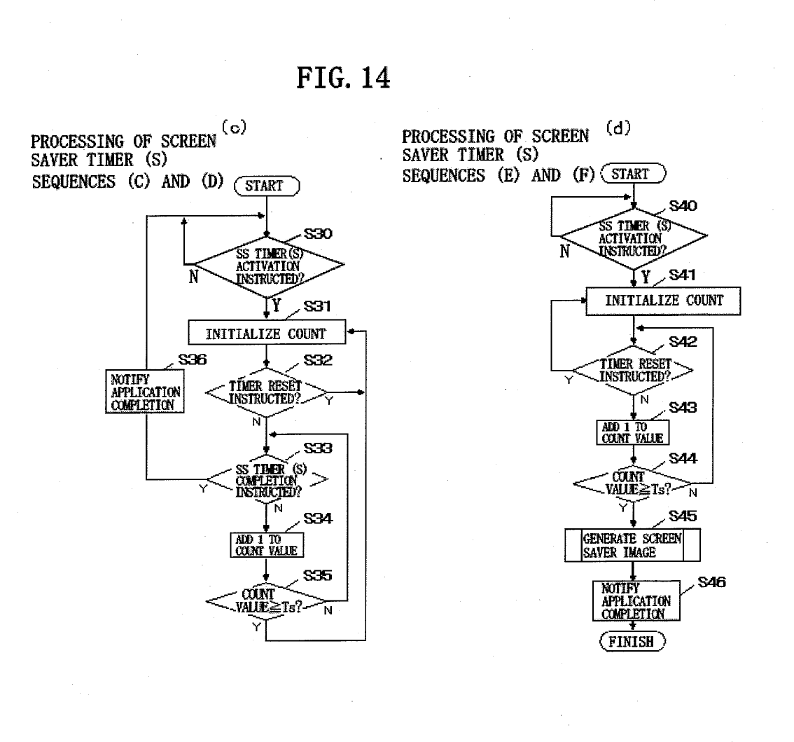

As for the screen saver timer (S), a program describing the operation procedures of the flow chart illustrated in FIG. 14(c) in JavaScript (registered trademark) can be applied.

The flow chart illustrated in FIG. 14(c) will be described. In step S30, the script processing unit 32 awaits an instruction for activation of the screen saver timer (S). An instruction for activation of the screen saver timer (S) refers to an instruction for application activation which is issued from the application control unit 40 and which is illustrated in the sequence chart illustrated in FIG. 6. When step S30 results in Yes, the script processing unit 32 proceeds to step S31 and initializes a count value of the screen saver timer (S). Next, the script processing unit 32 proceeds to step S32 and judges whether or not timer reset has been issued by the reset timer. When step S32 results in Yes, the script processing unit 32 returns to step S31 and initializes the count value of the screen saver timer (S). When step S32 results in No, the script processing unit 32 proceeds to step S33 and judges whether or not a completion instruction of the screen saver timer (S) has been issued. A completion instruction of the screen saver timer (S) refers to a video reproduction completion notification to be issued by the stream processing unit 34.

When step S33 results in No, the script processing unit 32 proceeds to step S34 and increases the count value of the screen saver timer (S) by 1. Next, the script processing unit 32 proceeds to step S35 to judge whether or not the count value of the screen saver timer (S) has reached Ts. When step S35 results in No, the script processing unit 32 returns to step S33 to continue counting. When step S35 results in Yes, the script processing unit 32 returns to step S31. When step S33 results in Yes, the script processing unit 32 proceeds to step S36 and notifies application completion to the application control unit 40. Moreover, normally, since Ts>Tr, count value Is never occurs.

Moreover, in the present third embodiment, the application completion notification outputted from the script processing unit 32 is to be screen saver control information. The screen saver control information is supplied as an instruction for screen saver restart to the screen saver processing unit 20 via the application control unit 40 to perform control. The dashed line in FIG. 5 represents a flow of screen saver control information. Moreover, instead of such a path, an instruction for screen saver restart may alternatively be supplied as screen saver control information by the script processing unit 32 to the screen saver processing unit 20.

### Fourth Embodiment

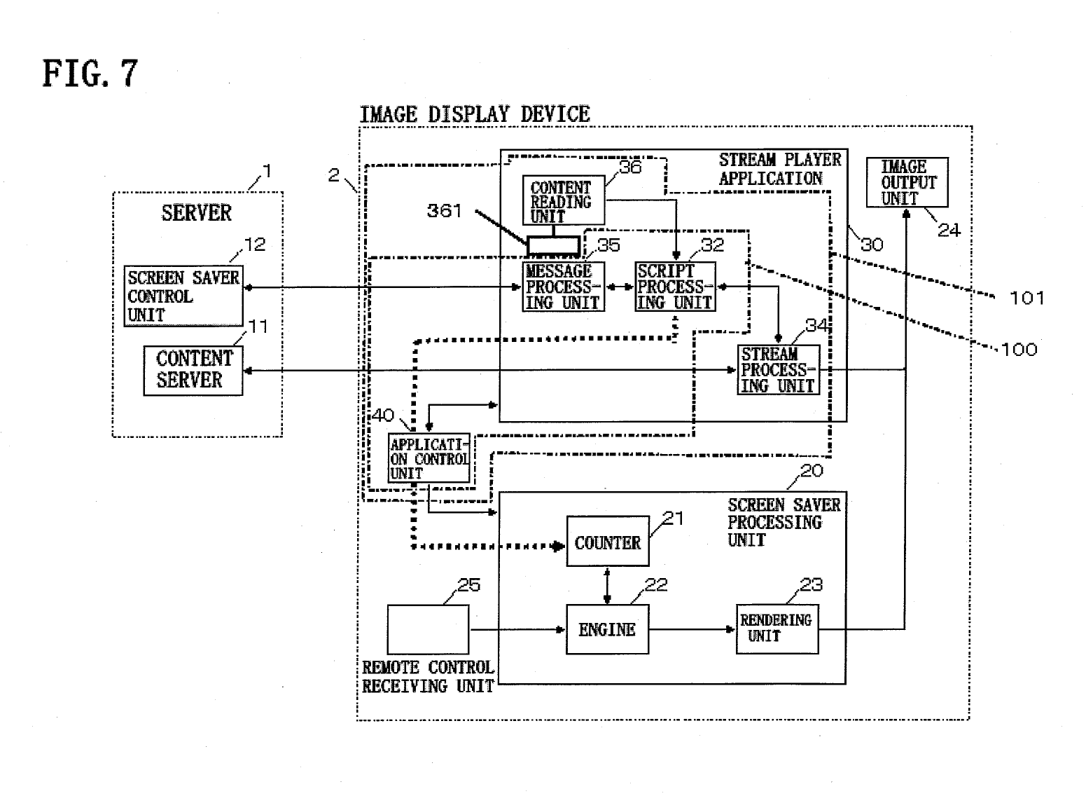

Next, FIG. 7 illustrates an example of a configuration of a screen saver control system arranged such that an image display device 2 internally stores content information and a part of processing thereof is to be performed by a server 1. Hereinafter, a description focusing on portions that differ from the respective embodiments above will be given.

In FIG. 7, the present fourth embodiment includes the server 1 and the image display device 2. The server 1 includes a content server 11 and a screen saver control unit 12. The content server 11 stores video stream information of image programs such as movies and news. The screen saver control unit 12 executes a part of processing related to the control of a start time of screen saver screen generation to be performed in the image display device 2. More specifically, the screen saver control unit 12 performs counting of a reset timer and generation of a timer reset message. To this end, the screen saver control unit 12 has a built-in first program which is described in a script format and which controls a generation timing of a screen saver. The first program will be described later.

The image display device 2 includes a screen saver processing unit 20, a stream player application 30, an image output unit 24, a remote control receiving unit 25, and an application control unit 40. The screen saver processing unit 20 is made up of a counter 21, an engine 22, and a rendering unit 23. The stream player application 30 includes a script processing unit 32, a stream processing unit 34, a message processing unit 35, and a content reading unit 36.

The script processing unit 32 has a built-in second program which is described in a script format and which controls a generation timing of a screen saver. The second program will be described later. Other components are similar to those described in the second embodiment.

Here, reference numeral 100 denotes an image control unit according to the present invention and includes the script processing unit 32, the message processing unit 35, and the application control unit 40.

In addition, reference numeral 101 denotes an image control processing unit according to the present invention and includes the image control unit 100 and the stream processing unit 34.

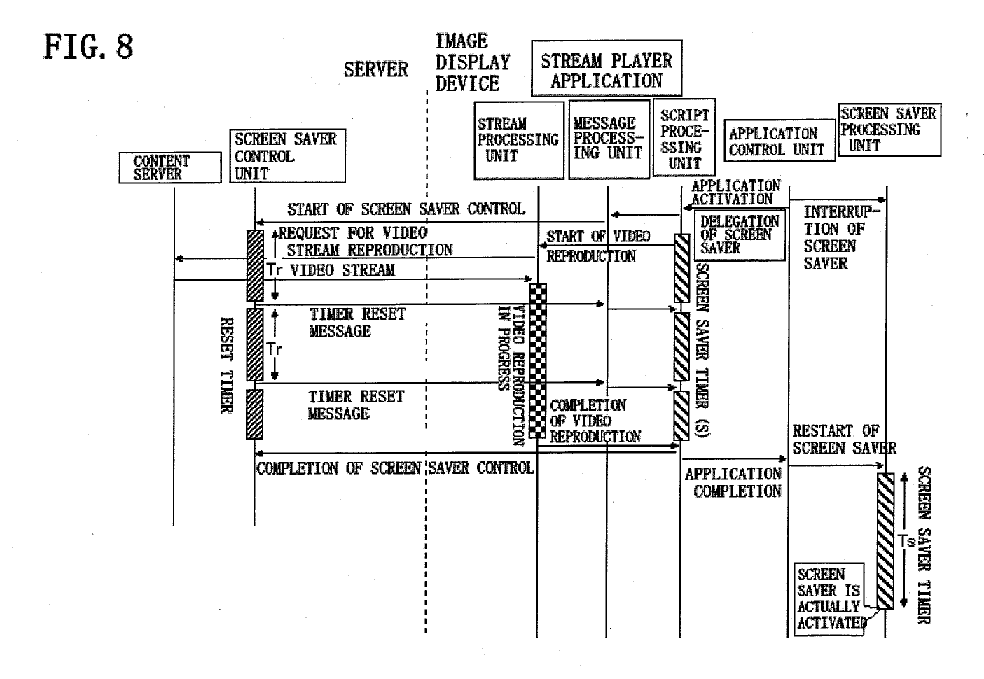

Operations of the present embodiment will be described below with reference to the sequence (D) diagram illustrated in FIG. 8.

The application control unit 40 is equipped with a function for controlling operations of the stream player application 30. Upon receiving a video reproduction instruction from a user, the application control unit 40 issues an application activation instruction to the stream player application 30. As a result, the script processing unit 32 of the stream player application 30 instructs the message processing unit 35 to transmit an instruction message for starting screen saver control. Based on the instruction, the message processing unit 35 generates an instruction message for starting screen saver control and transmits the message to the screen saver control unit 12.

Moreover, the application control unit 40 interrupts, or initializes and suspends, counting by the counter 21 of the screen saver processing unit 20 just before or after the aforementioned application activation instruction.

The screen saver control unit 12 of the server 1 includes procedures regarding screen saver control as a built-in first program. Upon receiving an instruction message for starting screen saver control, the screen saver control unit 12 activates a reset timer in the built-in program and starts counting. Every time a count value of the reset timer reaches Tr, the screen saver control unit 12 generates and transmits a timer reset message to the message processing unit 35.

On the other hand, the script processing unit 32 includes a counting function of a screen saver timer (S) as a built-in second program, and according to an application activation of the aforementioned application control unit 40, starts counting to a count value Ts. The screen saver timer (S) is a software timer expressed in a script language and is a designation used for distinguishing from the screen saver timer of the counter 21.

After the aforementioned application activation instruction from the application control unit 40, the script processing unit 32 of the stream player application 30 issues an instruction for starting video reproduction to the stream processing unit 34. Based on the instruction, the stream processing unit 34 makes a video stream reproduction request to the content server 11. The content server 11 transmits a video stream to the stream processing unit 34 according to the video stream reproduction request. The stream processing unit 34 receives the video stream, performs video reproduction, and enters a “video reproduction in progress” state.

The reset timer of the screen saver control unit 12 transmits a timer reset message to the message processing unit 35 every time the count value reaches Tr. Upon receiving a timer reset message, the message processing unit 35 performs timer reset on the screen saver timer (S) of the script processing unit 32 and causes counting of the screen saver timer (S) to be reactivated all over again.

When reproduction of the video stream is completed at the stream processing unit 34, the stream processing unit 34 notifies the completion of reproduction to the script processing unit 32. Upon receiving the notice, the script processing unit 32 suspends counting of the screen saver timer (S) and notifies application completion to the application control unit 40. Furthermore, the script processing unit 32 transmits a screen saver control completion message to the screen saver control unit 12.

Upon receiving the screen saver control completion message, the screen saver control unit 12 suspends counting of the reset timer. Moreover, an arrangement may be alternatively adopted in which the script processing unit 32 instructs the message processing unit 35 to transmit a screen saver control completion message and the message processing unit 35 transmits a screen saver control completion message to the screen saver control unit 12.

When notified of application completion, the application control unit 40 instructs screen saver restart to the screen saver processing unit 20. The screen saver processing unit 20 causes the counter 21 to start counting. When the count value of the counter 21 reaches Ts, the counter 21 activates the engine 22 that generates a screen saver image, a predetermined screen saver screen is rendered at the rendering unit 23, and the rendered screen saver screen is supplied to the image output unit 24. Thereafter, the image output unit 24 displays a screen saver screen.

A feature of the present embodiment is that instead of controlling a generation start time of a screen saver screen by an application itself of the screen saver processing unit 20 built into the image display device 2, counting operation by the screen saver timer (S) is controlled at the script processing unit 32 existing inside the stream player application 30 that is an application outside of the screen saver processing unit 20, based on an operation of the reset timer of the screen saver control unit 12 of the server 1.

While operation procedures regarding screen saver control described above by the script processing unit 32, the message processing unit 35, and the stream processing unit 34 may be respectively built into the script processing unit 32, the message processing unit 35, and the stream processing unit 34 in advance, the operation procedures regarding screen saver control described above may alternatively be stored in a script format as content information in a content storage unit 361, be read via the content reading unit 36, be interpreted by the script processing unit 32 and be supplied to the script processing unit 32, the message processing unit 35, and the stream processing unit 34.

In addition, while the screen saver control unit 12 is assumed to be provided in the server 1 in advance in the above description, the script processing unit 32 may be arranged so as to read out, via the content reading unit 36, the processing contents of the screen saver control unit 12, and transmit and supply the processing contents as a first program to the screen saver control unit 12.

Next, content information will be described. The first program which is a part of content information and which is to be executed by the screen saver control unit 12 may be similar to the program of reset timer processing procedures described with reference to the flow chart illustrated in FIG. 13(a). Moreover, processing of step S11 may be deleted and alternatively shifted to after step S15.

The second program to be executed by the script processing unit 32 may be similar to the program of processing procedures of the screen saver timer (S) described with reference to the flow chart illustrated in FIG. 14(c).

Moreover, in the present fourth embodiment, the application completion notification outputted from the script processing unit 32 is to be screen saver control information. The screen saver control information is supplied as an instruction for screen saver restart to the screen saver processing unit 20 via the application control unit 40 to perform control. A dashed line that extends from the script processing unit 32 to the counter 21 via the application control unit 40 in FIG. 7 indicates a flow of screen saver control information. Moreover, instead of such a path, an instruction for screen saver restart may alternatively be supplied as screen saver control information by the script processing unit 32 to the screen saver processing unit 20.

The operations of transmitting and receiving the various messages performed by the message processing unit 35 described above may alternatively be arranged to be also performed by the script processing unit 32. In this case, the message processing unit 35 can be omitted.

An example in which the reset timer issues a timer reset message has been described above. A timer reset message can have meaning of a screen saver prohibition message. A screen saver prohibition message may be arranged so as to be issued by an arbitrary event instead of according to counting of the reset timer.

### Fifth Embodiment

While the third embodiment described above is arranged so that a screen saver screen is generated by the rendering unit 23 of the screen saver processing unit 20 included in the image display device 2, the script processing unit 32 may alternatively be arranged so as to have rendering performed directly without involving the screen saver processing unit 20 as is the case of a present fifth embodiment.

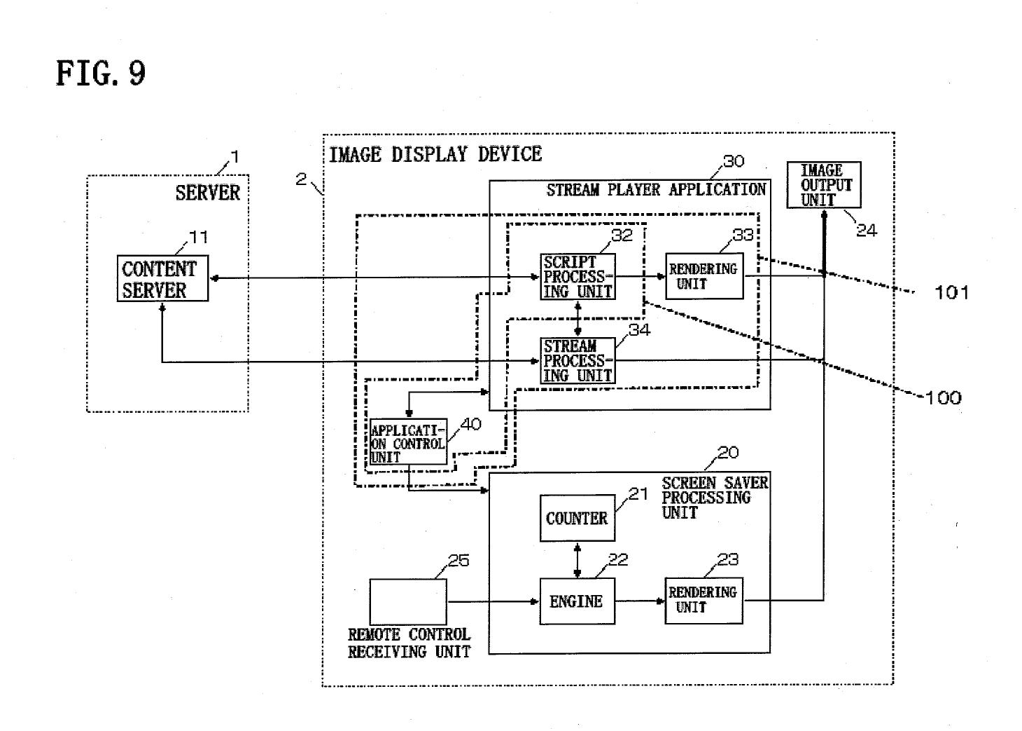

FIG. 9 illustrates a configuration of a system according to the present fifth embodiment. In FIG. 9, the present fifth embodiment includes a server 1 and an image display device 2.

The server 1 is similar to the content server 11 according to the third embodiment illustrated in FIG. 5.

The image display device 2 includes a screen saver processing unit 20, a stream player application 30, an image output unit 24, and a remote control receiving unit 25. The screen saver processing unit 20 is similar to the screen saver processing unit 20 according to the third embodiment illustrated in FIG. 5. The stream player application 30 includes a script processing unit 32, a rendering unit 33, and a stream processing unit 34. The script processing unit 32 is a script executing unit that executes content information described in JavaScript (registered trademark).

The rendering unit 33 is an image generating device that generates a screen saver image based on a result of execution of content information described in JavaScript (registered trademark) by the script processing unit 32. The stream processing unit 34 is a unit that decodes and converts video stream information received from the content server 11 into video image information.

The image output unit 24 is a display unit that displays video image information and a screen saver image. When the rendering unit 33 generates and outputs a screen saver image, the image output unit 24 outputs the screen saver image.

Moreover, in the present fifth embodiment, the screen saver processing unit 20 does not generate a screen saver image.

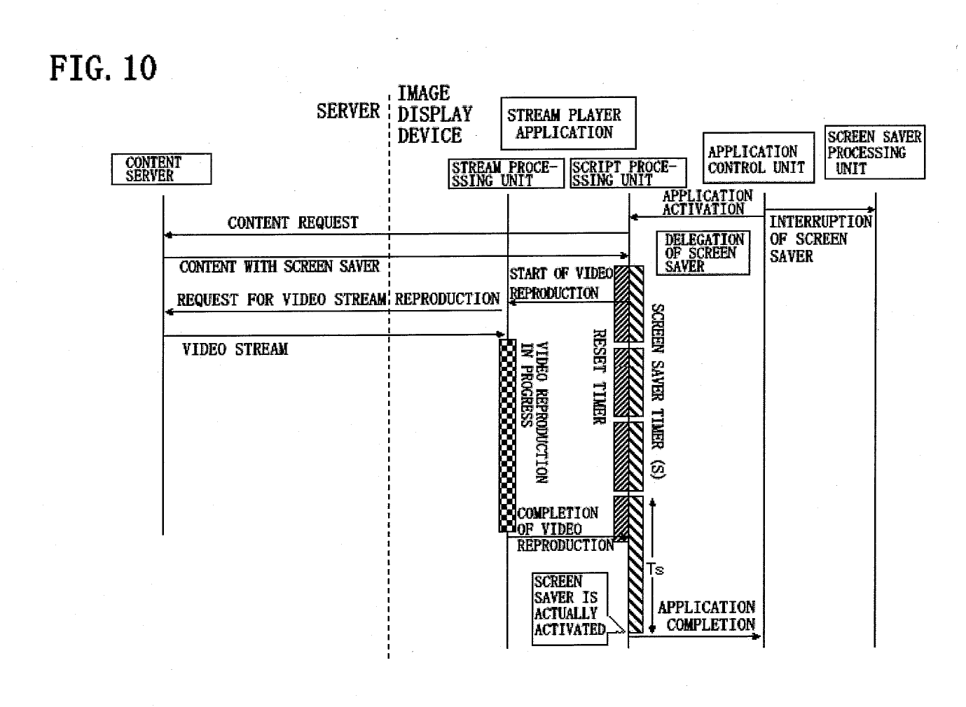

FIG. 10 illustrates a sequence (E) of processing according to the present fifth embodiment. While the sequence illustrated in FIG. 10 differs from the sequence illustrated in FIG. 6 according to the third embodiment by the following aspects, the sequence illustrated in FIG. 10 is otherwise the same as the sequence illustrated in FIG. 6.

In FIG. 10, when video reproduction is completed, the counting by a reset timer inside the script processing unit 32 is suspended and the reset timer does not reset a screen saver timer (S).

As a result, a count value of the screen saver timer (S) reaches Ts over time. At this point, the rendering unit 33 starts generating a screen saver screen and causes the image output unit 24 to display the screen saver screen. When generation of the screen saver screen is completed, the script processing unit 32 notifies application completion to an application control unit 40.

Therefore, the processing procedure according to the flow chart illustrated in FIG. 13(a) can be applied to a processing procedure of the reset timer to be executed by the script processing unit 32. In addition, the processing procedure according to the flow chart illustrated in FIG. 14(b) can be applied to a processing procedure of the screen saver timer (S) to be executed by the script processing unit 32.

In the flow chart illustrated in FIG. 14(d), in step S40, the script processing unit 32 judges whether or not an instruction for activating the screen saver timer (S) has been issued. The instruction is an application activation instruction from the application control unit 40. When step S40 results in Yes, the script processing unit 32 proceeds to step S41 and initializes a count value of the screen saver timer (S).

Next, the script processing unit 32 proceeds to step S42 and judges whether or not timer reset has been issued. In the present fifth embodiment, information regarding whether or not a timer reset has been issued becomes screen saver control information for controlling activation of generation processing of a screen saver image. If timer reset has been issued, a Yes result is obtained and the script processing unit 32 returns to step S41. When step S42 results in No, the script processing unit 32 proceeds to step S43 and increases the count value of the screen saver timer (S) by 1, and proceeds to step S44. In step S44, the script processing unit 32 judges whether or not the count value of the screen saver timer (S) has reached Ts. When the judgment result is No, the script processing unit 32 returns to step S42 to continue counting.

When step S44 results in Yes, the script processing unit 32 issues an instruction for generating a screen saver image to the rendering unit 33. Next, in step S46, the script processing unit 32 notifies application completion to the application control unit 40.

In the present fifth embodiment, control of generation timing of a screen saver screen and generation and display of the screen saver screen by the image display device 2 may be performed by a screen saver function built into the server 1. Since a screen saver screen based on the screen saver function built into the server 1 can be generated by the rendering unit 33 without having to use a screen saver screen generated by the screen saver processing unit 20 built into the image display device 2, an optimum screen saver screen for a video stream becomes usable.

In the above description, while the screen saver image generation program is arranged so as to be stored in advance as a third program in the rendering unit 33, the screen saver image generation program may alternatively be stored as a part of content information in the content server 11 to be received by the script processing unit 32 from the content server 11 and supplied to the rendering unit 33. The sequence in FIG. 10 illustrates the latter processing procedure.

The script processing unit 32 may be arranged so as to receive parameter information for specifying color and movement of an image, a background image, or the like to be used in the screen saver image generation program, from the content server 11, and to supply the parameter information to the rendering unit 33. In addition, the script processing unit 32 may be arranged so as to also perform the function of the rendering unit 33 by executing the third program to generate and output a screen saver image.

Moreover, the script processing unit 32 may also be arranged so as to activate the engine 22 and have the rendering unit 23 generate a screen saver screen at the point where the count value of the screen saver timer (S) reaches Ts. In this case, a screen saver screen generated by the screen saver processing unit 20 built into the image display device 2 is to be used. Even so, a screen saver timer included in the screen saver processing unit 20 is not to be used.

### Sixth Embodiment

While the fourth embodiment described above is arranged so that a screen saver screen is generated by the rendering unit 23 of the screen saver processing unit 20 included in the image display device 2, the script processing unit 32 may alternatively be arranged so as to have rendering performed directly without involving the screen saver processing unit 20.

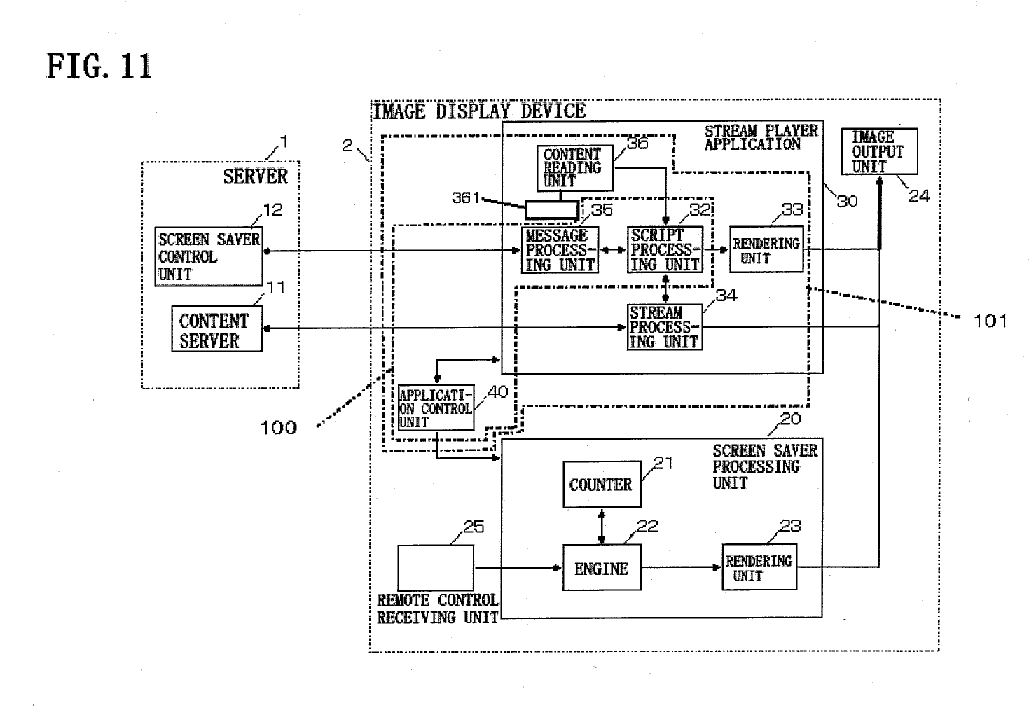

FIG. 11 illustrates a configuration of a system according to a present sixth embodiment. In FIG. 11, the present sixth embodiment includes a server 1 and an image display device 2. The server 1 is similar to the server 1 illustrated in FIG. 7 according to the fourth embodiment.

The image display device 2 includes a screen saver processing unit 20, a stream player application 30, an image output unit 24, a remote control receiving unit 25, and an application control unit 40. The screen saver processing unit 20 is similar to that according to the fourth embodiment and, as described in the first embodiment, includes a counter 21, an engine 22, and a rendering unit 23. The stream player application 30 includes a script processing unit 32, a rendering unit 33, a stream processing unit 34, a message processing unit 35, and a content reading unit 36.

The rendering unit 33 is a unit that generates a screen saver image when an instruction has been issued by the script processing unit 32. The message processing unit 35 generates a predetermined message based on an instruction from the application control unit 40, and transmits/receives message among the screen saver control unit 12 and the stream processing unit 34.

Moreover, in the present sixth embodiment, the screen saver processing unit 20 does not generate a screen saver image.

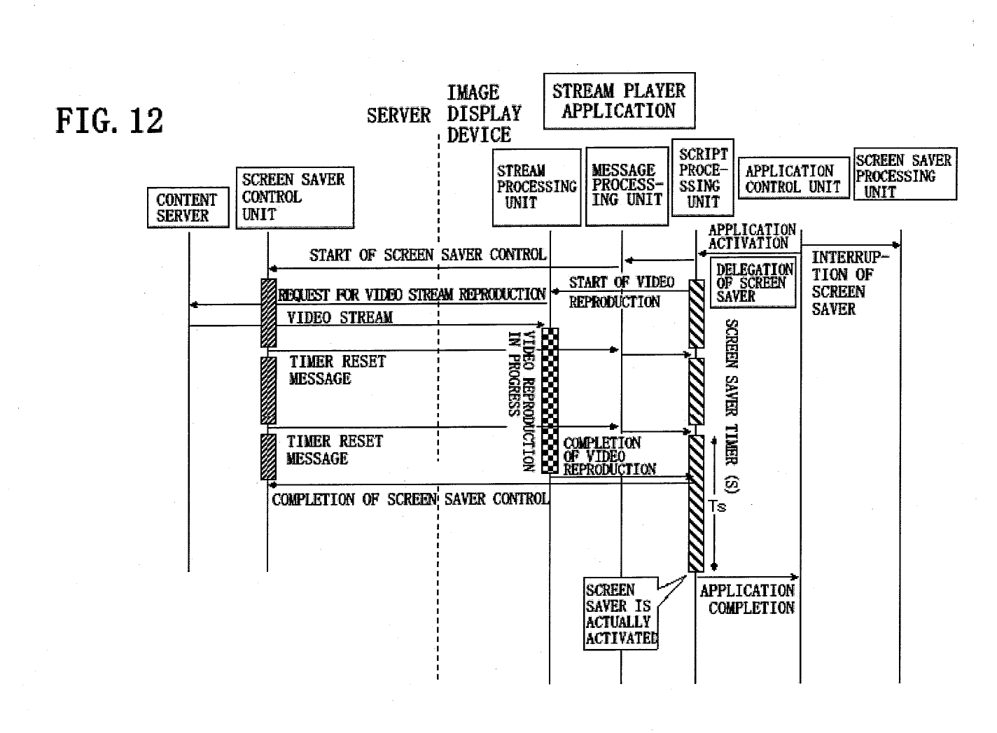

FIG. 12 illustrates a sequence of processing according to the present sixth embodiment. The sequence (F) illustrated in FIG. 12 is a partial modification of the sequence illustrated in FIG. 8 and described in the fourth embodiment. The modified portion will now be described.

In FIG. 12, when video reproduction is completed and the script processing unit 32 receives a notification of video reproduction completion, the script processing unit 32 causes a message of screen saver control completion to be transmitted to the screen saver control unit 12 via the message processing unit 35. The screen saver control unit 12 suspends counting by a reset timer, and a timer reset message is to be on longer transmitted to the message processing unit 35.

As a result, timer reset of a screen saver timer (S) inside the script processing unit 32 is no longer performed. Subsequently, a count value of the screen saver timer (S) reaches Ts with time.

At this point, the rendering unit 33 starts generating a screen saver screen and causes the image output unit 24 to display the screen saver screen. When generation of the screen saver screen is completed, the script processing unit 32 notifies application completion to an application control unit 40.

In the present sixth embodiment, control of generation timing of a screen saver screen and generation and display of the screen saver screen can be performed separate from a screen saver function of the screen saver processing unit 20 of the image display device 2.

In the same manner as in the fourth embodiment, the processing procedure according to the flow chart illustrated in FIG. 13(a) is applied to a processing procedure of the reset timer to be executed by the screen saver control unit 12. As described in the fourth embodiment, this processing procedure is a first program. The processing procedure according to the flow chart illustrated in FIG. 14(d) described in the fifth embodiment is applied to a processing procedure of the screen saver timer (S) to be executed by the script processing unit 32. This processing procedure is a second program.

The rendering unit 33 has a built-in screen saver image generation program that is a third program. A known screen saver image generation program can be used.

In the above description, while the screen saver image generation program is arranged so as to be built into the rendering unit 33 in advance as the third program, the screen saver image generation program may alternatively be read as a part of content information by the script processing unit 32 via the content reading unit 36 to be supplied to the rendering unit 33. That is, the content reading unit 36 may be arranged so as to read content information which is an operation procedure regarding screen saver control and which is stored in a script format in a content storage unit 361, and to supply the content information to the script processing unit 32. The script processing unit 32 is to interpret the content information and execute a predetermined program.

The processing procedure of the reset timer that is executed by the screen saver control unit 12 or, in other words, the first program may be stored in advance in the screen saver control unit 12 or may be read by the script processing unit 32 via the content reading unit 36 to be transmitted and supplied to the screen saver control unit 12. The processing procedure of the screen saver timer (S) that is executed by the script processing unit 32 or, in other words, the second program may be stored in advance in the script processing unit 32 or may be read by the script processing unit 32 via the content reading unit 36. In addition, the first program that is executed by the screen saver control unit 12 is not limited to a script format.

Moreover, the script processing unit 32 may also be arranged so as to activate the engine 22 and have the rendering unit 23 generate a screen saver screen at the point where the count value of the screen saver timer (S) reaches Ts. In this case, a screen saver screen generated by the screen saver processing unit 20 built into the image display device 2 is to be used.

The operations of transmitting and receiving the various messages performed by the message processing unit 35 described above may alternatively be arranged to be also performed by the script processing unit 32. In this case, the message processing unit 35 can be omitted.

Moreover, while an HDD recorder is a representative example of the server 1 in each of the first to sixth embodiments described above, a personal computer may also be used. The present invention can also be applied to a case where a personal computer supplies a video stream such as an moving image or Internet information to the image display device 2 to be displayed by the image display device 2. In addition, a device need not be installed in the home. Instead, for example, the device may be installed outside of the home or the device may be owned by a content provider connected via a network.

In addition, the image display device 2 need only be a device that receives a video stream such as a moving image or Internet information from the server 1 and displays the same. Therefore, the image display device 2 is a concept not only limited to a television but to also include devices provided with a display unit such as a laptop computer. Specifically, the present invention is applicable even to a case such as viewing a movie by displaying a video stream from the server 1 on a display unit of a personal computer.

Therefore, an operation of a first screen saver timer of the screen saver processing unit 20 of the image display device 2 is controlled via the screen saver control information described above (including a notification for interruption in the embodiments) and is also associated to another predetermined event. Another predetermined event refers to a keyboard of a personal computer or the like.

While a description has been given of the stream player application 30 as an example of an application in each of the first to sixth embodiments described above, the present invention is also applicable to an application for displaying a content of other digital media besides reproducing and displaying a video stream.

Transmission /reception of various messages, content information, video stream information, and the like in each of the first to sixth embodiments described above can be realized by known techniques for transmitting/receiving digital information.

While a description of JavaScript (registered trademark) has been given as content information in each of the first to sixth embodiments described above, other programs (including programs in other script formats) may be used.

While the screen saver control unit 12, the screen saver processing unit 20, the counter 21, the engine 22, the rendering unit 23, the stream player application 30, the script processing unit 32, the rendering unit 33, the stream processing unit 34, the message processing unit 35, and the application control unit 40 that make up the screen saver control systems illustrated in FIGS. 1, 3, 5, 7, 9, and 11 according to each of the first to sixth embodiments described above, can be realized by dedicated hardware (dedicated circuit), since everything involves processing of digital information, the components can normally be realized by software. Software of relevant processing need only be recorded on a ROM to be executed on a shared MPU or memory. Moreover, while the ROM is favorably a non-volatile recording medium such as a rewritable ROM, a volatile recording medium can also be used.

In addition, the sequence of the screen saver control method illustrated in FIGS. 2, 4, 6, 8, 10, and 12 according to each of the first to sixth embodiments described above can normally be realized by software. Relevant software need only be recorded on a ROM to be executed on a shared MPU or memory. Moreover, while the ROM is favorably a non-volatile recording medium such as a rewritable ROM, a volatile recording medium can also be used.

The script processing unit 32 may be arranged so as to receive parameter information for specifying color and movement of an image, a background image, or the like to be used in the screen saver image generation program from the content server 11, and supply the parameter information to the rendering unit 33. In addition, the script processing unit 32 may supply the parameters to the engine 22 or the rendering unit 23 of the screen saver processing unit 20. Such an arrangement enables the server 1 to generate a desired screen saver image at the image display device 2.

While a description of a program for screen saver control as content information has been given in each of the first to sixth embodiments described above, content information may also be an application program which is accompanied by a screen display having a screen saver control function. In this case, the effect of the present invention may be achieved with respect to the application program even when the image display device is not particularly receiving a video stream.

Moreover, it is assumed that “generation of screen saver control information” includes not only “outputting timer reset at a predetermined cycle” as described in the embodiments but also reading and the like of information (parameters and the like) corresponding to screen saver control information included in content information itself.

Furthermore, it is to be understood that the present invention is not limited to the respective embodiments described above and that various modifications may be made to the configurations of the embodiments, contents and expression formats of information, and procedures illustrated in the flow charts without departing from the spirit and the scope of the present invention.

A program according to the present invention is a program for causing a computer to execute the operation of the image display device according to the present invention and is a program which operates in cooperation with the computer.

Moreover, the recording medium of the present invention is a recording medium having recorded thereon the program of the above described image display device of the present invention and is a computer-readable recording medium, the program of which, when read, is used in cooperation with the computer.

A form of use of the program according to the present invention may be a form in which the program is recorded on a recording medium such as a ROM readable by a computer and operates in cooperation with the computer.

A form of use of the program according to the present invention may be a form in which the program is transmitted through a transmission medium such as the Internet or a transmission medium such as light or a radio wave, read by a computer, and operates in cooperation with the computer.

The computer according to the present invention explained above is not limited to pure hardware such as a CPU and may include firmware, an OS, and peripheral equipment.

As explained above, the configuration of the present invention may be realized in terms of software or may be realized in terms of hardware.

### INDUSTRIAL APPLICABILITY

The present invention can prevent the activation of a screen saver operation during the reproduction of the image or the displaying of the internet information on one device, and therefore the present invention is useful in such system in which two or more devices operate in cooperation with each other, as like such a case where a video program stored in a server such as a DVD recorder or a hard disk recorder (HDD recorder) is displayed on an image display device such as a television or a personal computer.

### REFERENCE SIGNS LIST

1 server
2 image display device
11 content server
12 screen saver control unit
20 screen saver processing unit
21 counter
22 engine
23 rendering unit
24 image output unit
25 remote control receiving unit
30 stream player application
32 script processing unit
33 rendering unit
34 stream processing unit
35 message processing unit
36 content reading unit
40 application control unit
100 image control unit
101 image control processing unit

1-27. (canceled)

28. An image display device comprising:
a stream processing unit that processes video stream information obtained from a server, to generate a video stream image;
a screen saver processing unit that has a screen saver timer and that generates a screen saver image using the screen saver timer;
an image output unit that outputs the video stream image and the screen saver image; and
an image control unit that resets the screen saver timer on a basis of a program obtained from the server, while the image output unit outputs the video stream image.

29. The image display device according to claim 28, wherein
an image control processing unit includes the image control unit and the stream processing unit,
the image control unit, based on the program obtained from the server, performs reset of the screen saver timer at a cycle Tr, using the image control unit's own timer, by transmitting to the screen saver processing unit a reset instruction for the screen saver timer as screen saver control information,
the image control unit suspends transmission of the screen saver control information to the screen saver processing unit in response to completion of reproduction by the stream processing unit, and
an operation of the screen saver timer in the screen saver processing unit follows the screen saver control information transmitted by the image control unit.

30. An image display device comprising:
a stream processing unit that processes video stream information obtained from a server, to generate a video stream image;
a screen saver processing unit that has a screen saver timer and that generates a screen saver image using the screen saver timer;
an image output unit that outputs the video stream image and the screen saver image; and
an image control unit, wherein
the server transmits a timer reset message to the image control unit every predetermined cycle Tr by using the server's own timer,
the image control unit receives the timer reset message and, based on the timer reset message, transmits, to the screen saver processing unit, a reset instruction for the screen saver timer as the screen saver control information,
the image control unit transmits, in response to the completion of reproduction by the stream processing unit, a screen saver control completion message to the server,
the server suspends counting of the server's own timer and also suspends transmission of the timer reset message upon receiving the screen saver control completion message, and
the image control unit suspends, in response to the suspension of transmission of the timer reset message, transmission, to the screen saver processing unit, of the reset instruction for the screen saver timer as the screen saver control information.

31. An image system comprising a server that accumulates and transmits encoded video stream information and an image display device that obtains and decodes the video stream information from the server and outputs an image, wherein
the image display device includes:
a screen saver processing unit that has a first screen saver timer and that generates a screen saver image by using the first screen saver timer; and
an image control processing unit which includes an image control unit that has a second screen saver timer and that controls generation of the screen saver image in the screen saver processing unit, and a stream processing unit that processes the video stream information, wherein
the image control processing unit controls the second screen saver timer and the screen saver processing unit by using screen saver control information which is generated by the image control processing unit itself or obtained from the server and which controls the second screen saver timer and the screen saver processing unit,
an operation of the first screen saver timer of the screen saver processing unit is associated, via the screen saver control information, to a state of processing of the stream processing unit and is also associated to another predetermined event, and
an operation of the second screen saver timer is associated to a state of processing of the stream processing unit.

32. An image display device which obtains and decodes video stream information from a server that accumulates and transmits encoded video stream information, and which outputs an image, the image display device comprising:
a screen saver processing unit that has a first screen saver timer and that generates a screen saver image by using the first screen saver timer; and
an image control processing unit which includes an image control unit that has a second screen saver timer and that controls generation of the screen saver image in the screen saver processing unit, and a stream processing unit that processes the video stream information, wherein
the image control processing unit controls the second screen saver timer and the screen saver processing unit by using screen saver control information which is generated by the image control processing unit itself or obtained from the server and which controls the second screen saver timer and the screen saver processing unit,
an operation of the first screen saver timer of the screen saver processing unit is associated, via the screen saver control information, to a state of processing of the stream processing unit and is also associated to another predetermined event, and
an operation of the second screen saver timer is associated to a state of processing of the stream processing unit.

33. The image display device according to claim 32, wherein
the first screen saver timer interrupts operation at least during image reproduction by the stream processing unit and restarts the operation due to an image reproduction completion notification that is the screen saver control information.

34. The image display device according to claim 33, wherein
the image control unit receives a program from the server, and based on the program, performs reset of the second screen saver time at a cycle Tr, by issuing, to the image control unit's own second screen saver timer, a reset instruction as the screen saver control information, and
according to the image reproduction completion notification from the stream processing unit, the image control unit suspends the reset instruction to the second screen saver timer and causes the first screen saver timer to restart operation.

35. The image display device according to claim 33, wherein
the image control unit receives a program from the server, and based on the program, performs reset of the second screen saver timer which is generated from the second screen saver timer program obtained from the server, at a cycle Tr, by issuing, to the second screen saver timer, a reset instruction as the screen saver control information, and
according to the image reproduction completion notification from the stream processing unit, the image control unit suspends the reset instruction to the second screen saver timer and causes the first screen saver timer to restart operation.

36. The image display device according to claim 33, wherein
the server transmits a timer reset message to the image control unit every predetermined cycle Tr by using the server's own timer,
the image control unit receives the timer reset message and, based on the timer reset message, issues a reset instruction, as the screen saver control information, to the second screen saver timer so as to perform reset of the second screen saver timer,
the image control unit suspends the reset instruction to the second screen saver timer and causes the first screen saver timer to restart operation, in response to the image reproduction completion notification from the stream processing unit,
the image control unit transmits, in response to the image reproduction completion notification from the stream processing unit, a screen saver control completion message to the server, and
the server suspends counting of the server's own timer and also suspends transmission of the timer reset message, upon receiving the screen saver control completion message.

37. The image display device according to claim 32, wherein
the other predetermined event is an event for executing predetermined application processing other than image reproduction of the video stream information.

38. A non-transitory computer-readable medium having a program stored thereon, wherein the program causes a computer to operate as:
the screen saver processing unit that has the first screen saver timer and that generates a screen saver image by using the first screen saver timer; and
the image control processing unit which includes the image control unit that has the second screen saver timer and that controls generation of the screen saver image in the screen saver processing unit, and the stream processing unit that processes the video stream information,
of the image display device according to claim 32.

39. An image system comprising a server that accumulates and transmits encoded video stream information and an image display device that obtains and decodes the video stream information from the server and outputs an image, wherein
the image display device includes:
a screen saver processing unit that has a first screen saver timer; and
an image control processing unit which includes a rendering unit that generates a screen saver image, an image control unit that has a second screen saver timer and controls the rendering unit, and a stream processing unit that processes the video stream information, wherein
the image control processing unit controls the second screen saver timer by using screen saver control information which is generated by the image control processing unit itself or obtained from the server and which controls the second screen saver timer, and
the second screen saver timer is associated to a state of processing of the stream processing unit via the screen saver control information.

40. An image display device that obtains and decodes video stream information from a server that accumulates and transmits encoded video stream information and which outputs an image, the image display device comprising:
a screen saver processing unit that has a first screen saver timer; and
an image control processing unit which includes a rendering unit that generates a screen saver image, an image control unit that has a second screen saver timer and controls the rendering unit, and a stream processing unit that processes the video stream information, wherein
the image control processing unit controls the second screen saver timer by using screen saver control information which is generated by the image control processing unit itself or obtained from the server and which controls the second screen saver timer, and
the second screen saver timer is associated to a state of processing of the stream processing unit via the screen saver control information.

41. An image display device that obtains and decodes video stream information from a server that accumulates and transmits encoded video stream information and which outputs an image, the image display device comprising:
a screen saver processing unit that has a rendering unit generating a screen saver image and a first screen saver timer; and
an image control processing unit which includes an image control unit that has a second screen saver timer and controls the rendering unit, and a stream processing unit that processes the video stream information, wherein
the image control processing unit controls the second screen saver timer by using screen saver control information which is generated by the image control processing unit itself or obtained from the server and which controls the second screen saver timer, and
the second screen saver timer is associated to a state of processing of the stream processing unit via the screen saver control information.

42. The image display device according to claim 40, wherein
the first screen saver timer interrupts operation at least during image reproduction by the stream processing unit and the second screen saver timer restarts operation after the completion of image reproduction.

43. The image display device according to claim 42, wherein
the image control unit receives a program from the server, and based on the program, performs reset of the second screen saver timer at a cycle Tr by issuing, to the image control unit's own second screen saver timer, a reset instruction as the screen saver control information, and
according to an image reproduction completion notification from the stream processing unit, the image control unit suspends the reset instruction to the second screen saver timer and controls the rendering unit based on counting of the second screen saver timer.

44. The image display device according to claim 42, wherein
the image control unit receives a program from the server, and based on the program, performs reset of the second screen saver timer which is generated from the second screen saver timer program obtained from the server, at a cycle Tr by issuing, to the second screen saver timer, a reset instruction as the screen saver control information, and
according to an image reproduction completion notification from the stream processing unit, the image control unit suspends the reset instruction to the second screen saver timer and controls the rendering unit based on counting of the second screen saver timer.

45. The image display device according to claim 42, wherein
the server transmits a timer reset message to the image control unit every predetermined cycle Tr by using the server's own timer,
the image control unit receives the timer reset message and, based on the timer reset message, issues a reset instruction, as the screen saver control information, to the second screen saver timer and performs reset of the second screen saver timer,
the image control unit suspends the reset instruction to the second screen saver timer and controls the rendering unit, based on counting of the second screen saver timer in response to an image reproduction completion notification from the stream processing unit,
the image control unit transmits, in response to the image reproduction completion notification from the stream processing unit, a screen saver control completion message to the server, and
the server suspends counting of the server's own timer and also suspends transmission of the timer reset message upon receiving the screen saver control completion message.

46. The image display device according to claim 40, wherein
the other predetermined event is an event for executing predetermined application processing other than image reproduction of the video stream information.

47. A non-transitory computer-readable medium having a program stored thereon, wherein the program causes a computer to operate as:
the screen saver processing unit that has the first screen saver timer and that generates a screen saver image by using the first screen saver timer; and
the image control processing unit that has the rendering unit which generates the screen saver image, the image control unit which has the second screen saver timer, controls the rendering unit and controls the screen saver processing unit, and the stream processing unit which processes the video stream information,
of the image display device according to claim 40.

48. The image display device according to claim 30, wherein
the server executes a program in a script format that controls a timing of a generation start time of a screen saver screen.
